(19) United States
(12) Patent Application Publication
(10) Pub. No.: US 2004/0094621 A1
(43) Pub. Date: May 20, 2004

(54) Automated ticketing system and method for law enforcement

(76) Inventor: Carl LaMont, New Hope, PA (US)

Correspondence Address: Eric A. LaMorte, LaMorte & Associates, P.C., P.O. Box 434, Yardley, PA, 19067, US

(21) Appl. No.: 10/299,546

(22) Filed: Nov. 20, 2002

(51) Int. Cl. G07B 15/02

(52) U.S. Cl. 235/384

(57) ABSTRACT

A system and method for law enforcement personnel to issue tickets in a manner that greatly eliminates the possibilities of human error in producing, issuing and tracking tickets. The system includes a vehicle information scanner that scans a vehicle and obtains vehicle information about that vehicle. The system may also include a driver's license scanner for scanning a person's driver's license. An input interface is provided that enables a law enforcement officer to electronically select a ticketable offense from a menu of potential ticketable offenses. The information scanned from the vehicle, scanned from the driver's license and selected for the ticketable offense is then used to electronically complete a ticket. The ticket is then printed and presented to the offender.

### BACKGROUND OF THE INVENTION

1. Field Of The Invention

In general, the present invention system and method relate to ticketing systems used by law enforcement agencies. More particularly, the present invention relates to ticketing systems that contain automated features that increase the efficiency and accuracy of the ticketing process.

2. Prior Art Description

Most modern police patrol vehicles are equipped with computers. The computers communicate with a central state or local database. The computers are used to check the license plates and driver's license information of people who are stopped by the police.

In order for a police officer to check a license plate number or a driver's license number, a police office must enter that number into the computer. The computer will send the entered number to the central database and retrieve the state records for that vehicle or person. In this manner, a police office can check if a vehicle is stolen or if a person is wanted by law enforcement. Typically, the exchange of data between an officer's squad car and the central database computer takes a few minutes. If a police officer is on foot or otherwise away from a squad car, the police officer must radio the information to their precinct house. The information is then checked at the precinct house and radioed back to the officer. This too takes several minutes.

Because it takes several minutes to check the information on a vehicle or person, police officers typically do not randomly check vehicles or people unless they have good cause. As such, information on a vehicle or a person is typically not checked until the police office observes a violation of the law. For example, a police officer typically does not check the license plate of a vehicle and the vehicle's driver's license until the officer has pulled over a vehicle for some traffic violation. Once a vehicle is stopped for a violation, procedural protocol requires the officer check the information on both the vehicle and the driver.

Many policemen believe that the most dangerous part of their job comes when the police officer approaches a vehicle that has just been stopped. As such, police officers almost always check the license plate number of a stopped vehicle prior to leaving the squad car and approaching the stopped vehicle for any reason.

If a police officer observes a violation, the police officer may elect to issue a ticket for that violation. In order to write a ticket, the police officer typically must physically complete a paper form. This also takes several minutes. The information gathered in the squad car computer is manually reproduced on the ticket form. Often, due to human error, poor lighting, time constraints, weather conditions and the like, the information written on the ticket is missing, erroneous or illegible. Consequently, when the police officer's ticket information is turned in at the end of his/her shift, the information regarding the citation either is erroneously entered into a tracking system or the ticket is never entered into the tracking system at all. As such, many people get away with ignoring tickets and other people who never received a ticket get accused of being a scofflaw.

In the prior art, systems have developed that help police offices do their jobs. Most of these systems involve the automation of the reading of a vehicle's license plate number. For example, U.S. Pat. No 4,817,166, to Gonzalez, et al., discloses a system for reading a license plate. The Gonzalez system contains both a video camera to produce an image of a license plate on a vehicle, and a scanning means to locate a license plate number in the image. The identification of the license plate number is verified in a confidence check by checking for the presence of a state logo.

U.S. Pat. No. 5,381,155 to Gerber discloses a method and system of traffic control by measuring the speed of passing vehicles. The system automatically reads the license plate of a passing vehicle. The system then uses a computer system to automatically match the license plate number with information about the owner of the vehicle. The system then displays the name of the owner of the vehicle.

U.S. Pat. 6,081,206 to Kielland discloses a parking regulation enforcement system having a video camera mounted on a parking enforcement patrol vehicle. The system is driven along a patrol route where parked vehicles are governed by a posted time limit. The system enforces the local parking regulation by reading license plate numbers and automatically determining whether or not each parked car has been parked longer than the posted time limit.

U.S. Pat. No. 6,433,706 to Anderson III, et al., discloses a system where a scanner automatically scans any license plate that passes in front of a police car, whether or not the police office wants to have the license plate scanned.

Each of the above described license plate readers is completely automated. As a result, a little time is saved by a police office in checking a vehicle's license plate. However, such systems do not help a police office check a driver's license or produce a ticket for a violation that is both accurate and legible.

A need therefore exists for a system and method that can reduce the amount of time it takes a police officer to issue a ticket and increase the accuracy of the information contained on the ticket. This need is met by the present invention as described and claimed below. As such, a police office can more efficiently issue tickets. Thus, less police officers will be required to monitor ticketable violations and officers on duty will have more of an opportunity to patrol for crime.

### SUMMARY OF THE INVENTION

The present invention is a system and method for law enforcement personnel to issue tickets in a manner that greatly eliminates the possibilities of human error in producing, issuing and tracking the ticket. The system can be embodied in either a police vehicle or in a handheld unit. The system includes a vehicle information scanner that scans a vehicle and obtains information about that vehicle. That vehicle information is then checked against a central database to determine if the vehicle is stolen or otherwise wanted by law enforcement. The system may also include a driver's license scanner for scanning a person's driver's license and reading information from the driver's license.

An input interface is provided that enables a law enforcement officer to electronically select a ticketable offense from a menu of potential ticketable offenses. The information scanned from the vehicle, scanned from the driver's license and selected for the ticketable offense is then used to electronically complete a ticket. The ticket is then printed and presented to the offender.

The system retains information about issued tickets until that information is downloaded to a central tracking system that tracks the ticket. Since the ticket information is gathered and selected electronically, the information for each ticket is subject to only a minimal amount of processing error. This results in tickets that contain accurate and reliable information. Furthermore, the improved efficiencies allow less police officers to monitor ticketable offenses and produce the same number of citations. Furthermore, since the police take less time to create tickets, more time can be spend on monitoring crime.

### BRIEF DESCRIPTION OF THE DRAWING

For a better understanding of the present invention, reference is made to the following description of exemplary embodiments thereof, considered in conjunction with the accompanying drawings, in which:

FIG. 1 is a side view of a police vehicle equipped with the present invention system, shown scanning a target vehicle;

FIG. 2 is a perspective view of an exemplary embodiment of a handheld embodiment of the present invention system;

FIG. 3 is a block diagram schematic of the electronic components of the present invention system; and

FIG. 4 is a block diagram logic flow showing the method of operation of the present invention system.

### DETAILED DESCRIPTION OF THE DRAWINGS

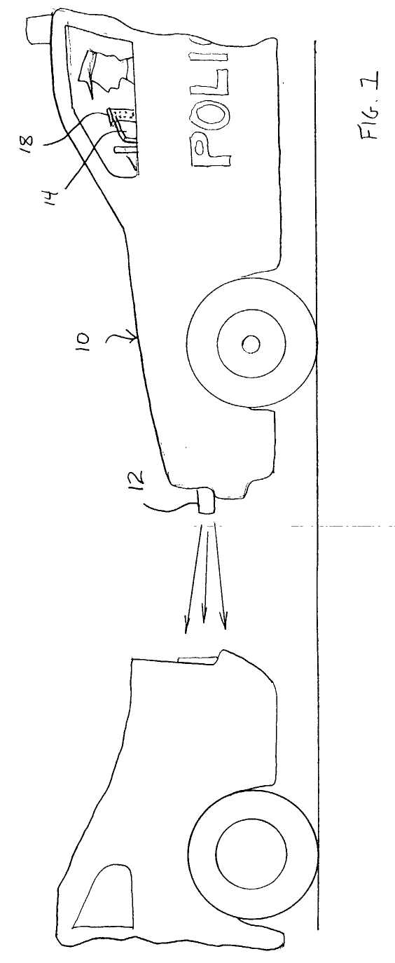

The present invention system can be embodied either as a portable handheld unit or as a system integrated into a police vehicle. In FIG. 1, the latter embodiment is illustrated, wherein the present invention is embodied within a police vehicle. Referring to FIG. 1, it can be seen that the present invention contains two scanners. One scanner is a vehicle information scanner 12. The second scanner is a driver information scanner 14. In the embodiment of FIG. 1, the vehicle information scanner 12 is mounted to the front of the police vehicle 10. The vehicle information scanner 12 can be any scanner capable of electronically or optically scanning a target vehicle 16 and reading information about that target vehicle 16. The preferred vehicle information scanner 12 is an optical scanner that can read the alphanumeric characters of a license plate. Such optical systems are known and used in the prior art. However, if the target vehicle 16 contains a bar code, the vehicle information scanner 12 can be a bar code reader. Likewise, if the target vehicle contains an electronic transponder, such as an electronic toll payment pass, the vehicle information scanner 12 can be a scanner that transmits a signal to activate the transponder and then reads the electronic information transmitted by the transponder.

The vehicle information scanner 12 is connected to a computer terminal 18 within the police vehicle 10. By using the computer terminal, a police officer can use the vehicle information scanner 12 to scan a target vehicle 16 without ever having to exit the police vehicle 10. This enables the police officer to determine if a target vehicle 16 is stolen or owned by a fugitive. If it is, a police officer can call for back-up before exiting the safety of the police vehicle 10 and exposing himself to danger.

The present invention system also contains a driver identification scanner 14. The driver identification scanner 14 is used to scan the driver's license of the driver of the target vehicle 16. The driver identification scanner 14 can contain an optical scanner that reads the driver's license number printed on a license. Alternatively, if the driver's license is the type that contains a magnetic information strip, the driver identification scanner 14 can be a magnetic strip reader.

Typically, when a police officer approaches a vehicle that has been pulled over for some violation, the officer takes the license of the driver and the registration of the vehicle back to the police vehicle for analysis. By providing the driver identification scanner 14 within the police vehicle, the police officer can quickly scan the driver's license when the officer returns to his vehicle with the license.

The other elements of the present invention, such as a computer interface and printer, are also be located in the police vehicle. The purpose of these elements will be later explained.

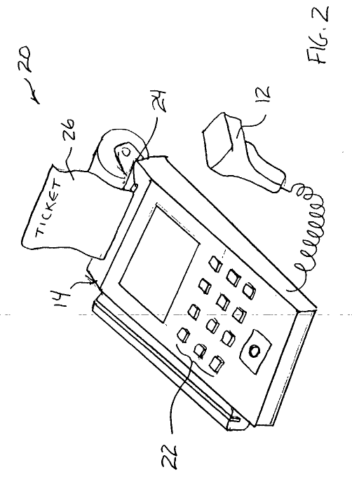

As has been mentioned, the embodiment of the present invention system within a police vehicle is merely exemplary. The present invention system can also be embodied in a handheld unit. Referring to FIG. 2, such a handheld unit is illustrated. The handheld unit 20 can be carried by a police officer, meter maid or any other law enforcement personnel. The handheld unit 20 contains both a vehicle identification scanner 12 and a driver identification scanner 14. The vehicle identification scanner 12 is the same as that previously described in reference to FIG. 1, except the vehicle identification scanner 12 is coupled to the handheld unit 20 rather than to a police vehicle, wither by cable or by a remote radio signal link. The vehicle identification scanner 12 is used by simply holding the scanner in front of a license plate of a target vehicle and activating the device. Similarly, the driver identification scanner 14 is also contained in the handheld unit 20. In the shown embodiment, the driver identification scanner 14 is a magnet card swipe reader that can read data from driver's licenses that contain magnetic strips. A police officer can therefore carry the handheld unit 20 up to the window of any vehicle and scan the information from that vehicle's driver without ever having to leave the side of the vehicle.

The handheld unit 20 also contains an input interface 22 for controlling the unit and a printer assembly 24 for printing a ticket 26. The purpose of these elements are described later in this specification.

One of the purposes of the present invention system is to automate the typical ticketing process so that a police officer or meter maid can produce a ticket quickly that is highly accurate and legible.

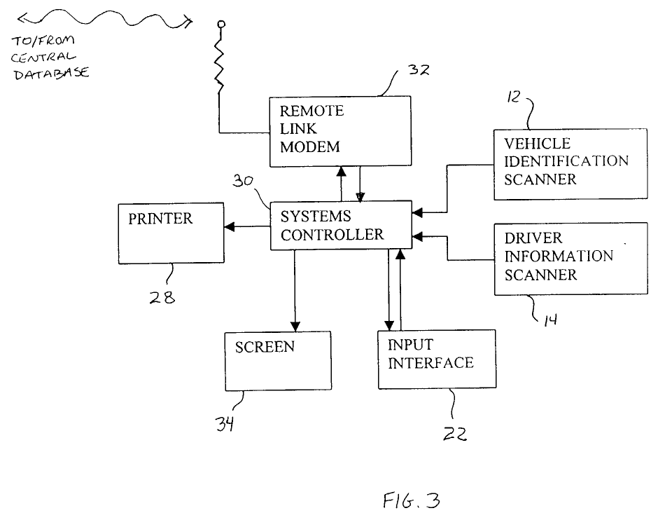

Referring now to FIG. 3, a schematic of the present invention is shown that can be embodied in a police vehicle 10, such as is shown in FIG. 1, or embodied in a handheld unit 20, such as is shown in FIG. 2. In either embodiment, it has already been explained that the present invention system contains a vehicle identification scanner 12 for scanning information from a vehicle and a driver identification scanner 14 for scanning information from a driver's license.

The information received from the vehicle information scanner 12 and/or the license information scanner 14 is received by a systems controller 30. In the handheld unit 20 (FIG. 2), the systems controller 30 is contained within the structure of the unit. When the system is applied to a police vehicle, the computer contained in the police vehicle can be utilized as the systems controller 30 of the system.

The systems controller 30 is coupled to a remote link modem 32 that allows the systems controller 30 to exchange data with a central computer system using either a radio link or a telecommunications link. In this manner, the information obtained about a particular vehicle or driver's license can be sent to the central computer system. The central computer system can then recall state records concerning the vehicle or driver in question. Information regarding stolen vehicles, drivers wanted on warrants, scofflaws and the like can then be quickly ascertained and transmitted back to systems controller 30.

The systems controller 30 is coupled to a screen 34 where information can be displayed. On the handheld unit 20 (FIG. 2), such a monitor would be provided as part of the unit. In a police vehicle mounted unit, the computer screen already existing in the police vehicle can be utilized.

An input interface 22 is also provided. The input interface 22 enables a police officer to interact with the systems controller 30, by inputting and requesting various data. The input interface 22 can be a computer keypad. However, mouse controls and touch-screen controls can also be used. Again, on a handheld unit 20 (FIG. 2), such an input interface would be provided as part of the unit. In a police vehicle mounted unit, the control interface already existing in the police vehicle can be utilized.

A printer assembly 28 is coupled to the systems controller 30. The printer assembly 28 is used to create the paper ticket that is given to an offending party. This is the only paper generated in this, otherwise, paperless system. All the information present on the ticket is electronically generated. Any information about the driver is taken directly from the scan of the driver's license. Any information about the vehicle is taken directly from information retrieved from the scan of the vehicle.

Accordingly, material mistakes concerning the vehicle and/or the driver is no longer subject to direct human error. Furthermore, the system provides accurate information on the ticket regardless of lighting conditions, weather conditions or any other variable condition experienced by a police officer when issuing a ticket. Information that is not scanned, such as the type of violation being ticketed, is selected from an electronic menu. Accordingly, the ticket is always printed clearly and legibly.

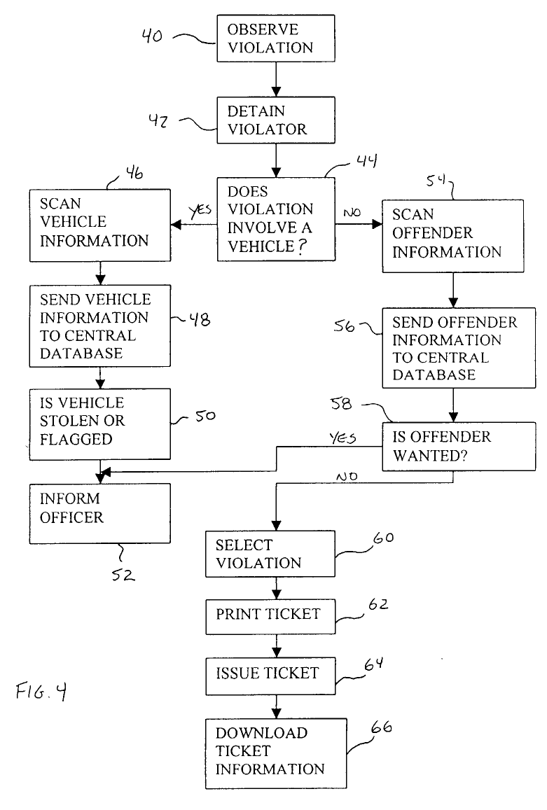

Referring now to FIG. 4, the method of utilizing the present invention system is described. As is indicated by Block 40, a police officer, meter maid or other law enforcement personnel first observes a ticketable offense. For example, a police squad car detects a vehicle exceeding the posted speed limit on a road. Alternatively, a policeman on foot in a park observes someone littering. After the violation is observed, the police officer detains the violator. See Block 42. If the violator is in a vehicle, the vehicle is pulled over. If the violator is on foot, the violator is asked to produce identification.

As is indicated in Block 44 and Block 46, when a violator is in a vehicle, or if the violation is caused by an illegally parked vehicle, the vehicle is scanned with the vehicle identification scanner. Information concerning the license plate number of the vehicle is read to the systems controller. This information is then sent to the central state database, as indicated by Block 48. If the vehicle is stolen or otherwise wanted, such an indication is sent back to the police officer who made the scan. See Block 50 and Block 52. The police officer can then call the impoundment yard to impound the vehicle. If the vehicle was used in a crime, the police officer can call the appropriate detectives so that the vehicle can be inspected for evidence.

If the vehicle is not identified as being wanted or otherwise flagged, the police officer approaches the vehicle and asks the driver of the vehicle for identification. Similarly, if a police officer observes a ticketable offence by a person not in a vehicle, the officer will ask the offender for identification. Once the identification is obtained, the offender's identification is scanned into the present invention system. See Block 54.

As is indicated by Block 56 and Block 58, the driver's information is read by the present invention system. Information from the identification is then read back to a central database. The information is checked to see if the person is wanted by law enforcement for any reason. That information is then relayed back to the officer. See Block 52.

Once a police officer has checked a vehicle and/or the driver of the vehicle with the present invention system, the officer produces a ticket for the observed offense. Preferably, the officer selects the offense from a menu of possible ticketable offenses that are displayed on the screen of the system. See Block 60. As has been previously explained, the police officer can select an offense from the menu using a keypad, a mouse or a touch screen.

Once a police officer selects a ticketable offense, the present invention system now contains all the information needed to produce a ticket. The information about a vehicle is taken directly from a scan of the vehicle. The information of the vehicle's driver is taken directly from the driver's license. Lastly, the information about the violation is taken directly from an electronic menu. As such, the only information subject to human error is the selection of the ticketable offense from the electronic menu. All other information is collected in an automated fashion.

As is indicated by Block 62, the present invention system prints a paper ticket containing the information that was gathered through the scans and selected from the menu by the police officer. The paper ticket is then either given or mailed to the offender, as is indicated by Block 64. The information regarding the ticket that was issued is still retained electronically within the system. As is indicated by Block 66, at various times, an officer can download the information into a central tracking system. The central tracking system tracks if and when various tickets are paid. Tracking systems for tickets are already used by most every municipality in the United States. However, using the present invention system, information about tickets is electronically transferred to the tracking system. Common errors, such as entry errors, and errors in reading information from blurred paper ticket stubs are eliminated by the present invention. The tracking system, therefore, contains much more accurate information.

It will be understood that the embodiments of the present invention system illustrated are merely exemplary and that a person skilled in the art can alter the embodiments into configurations not shown. For example, programmers can create many programs that operate in the method of the present invention. The screens and instructions presented to a police officer for use are a matter of design choice for the programmer. All such, alternate embodiments are intended to be included within the scope of the present invention as described and claimed below.

What is claimed is:

1. A ticketing system for law enforcement personnel, said system including:
a vehicle information scanner for scanning a vehicle from a point external of the vehicle, thereby obtaining vehicle information about that vehicle;
a driver's license scanner for scanning a driver's license and reading driver's information from the driver's license;
an input interface for selecting a ticketable offense;
a ticket printer; and
a systems controller for reading said vehicle information from said vehicle information scanner, reading said driver's information from said driver's license scanner, reading the ticketable offense selected by the input interface and causing said printer to print a ticket containing said vehicle information, said driver's information and an indication of said ticketable offense.

2. The system according to claim 1, wherein said vehicle information scanner scans the license plate of a vehicle.

3. The system according to claim 1, wherein said vehicle information scanner is selected from a group consisting of optical scanners, barcode scanners and transponder scanners.

4. The system according to claim 1, wherein said driver's license scanner is an optical scanner that scans information from a printed driver's license.

5. The system according to claim 1, wherein said driver's license scanner is a magnetic strip reader that reads information encoded on a magnetic strip on a driver's license.

6. The system according to claim 1, wherein said vehicle information scanner, said driver's license scanner, said input interface, said ticket printer, and said systems controller are contained in a law enforcement vehicle.

7. The system according to claim 6, wherein said vehicle information scanner, said driver's license scanner, said input interface, said ticket printer, and said systems controller are contained in a hand-held unit.

8. A method of producing a ticket, comprising the steps of:
electronically scanning a vehicle to gather vehicle information;
electronically selecting a ticketable offense from a selection of ticketable offenses;
electronically printing a ticket containing said vehicle information and said ticketable offense.

9. The method according to claim 8, further including the step of electronically scanning the driver's license of the driver of said vehicle to obtain driver information.

10. The method according to claim 9, further including the step of including said driver information on said ticket.

11. The method according to claim 8, wherein said step of electronically scanning a vehicle includes optically scanning a license plate of said vehicle.

12. The method according to claim 8, wherein said step of scanning a vehicle includes scanning a barcode on said vehicle.

13. The method according to claim 8, wherein said step of electronically selecting a ticketable offense from a selection of ticketable offenses includes the substeps of:
providing a menu of ticketable offenses;
enabling a law enforcement officer to electronically select at least one ticketable offense from said menu.

14. A method for law enforcement to issue tickets, comprising the steps of:
electronically scanning information from an offender at the site of the offense;
electronically selecting an offense from a plurality of possible offenses at the site of the offense; and
printing a paper ticket at the site of the offense using the information scanned and the offense.

15. The method according to claim 14, wherein said step of electronically scanning information from an offender at the site of the offense, includes electronically scanning the license plate of a vehicle involved in a ticketable offense.

16. The method according to claim 15, wherein said step of electronically scanning information from an offender includes scanning the offender's driver's license.

17. The method according to claim 15, further including the step of comparing information obtained by scanning said license plate to a central database containing information on vehicles wanted by law enforcement.

18. The method according to claim 16, further including the step of comparing information obtained by scanning said driver's license to a central database containing information on people wanted by law enforcement.

19. The method according to claim 14, further including the step of electronically downloading information on tickets issued to a central ticket tracking database.
